(19) United States
(12) Patent Application Publication
(10) Pub. No.: US 2008/0152467 A1
(43) Pub. Date: Jun. 26, 2008

(54) Cableway Installation with a Garage for Transportation Devices

(75) Inventor: Johannes Moritzhuber, Hard (AT)

Correspondence Address: LERNER GREENBERG STEMER LLP, P O BOX 2480, HOLLYWOOD, FL, 33022-2480, US

(73) Assignee: INNOVA PATENT GMBH, Wolfurt (AT)

(21) Appl. No.: 11/949,876

(22) Filed: Dec. 4, 2007

(30) Foreign Application Priority Data
Dec. 4, 2006 (AT) A2011/2006

(51) Int. Cl. B65G 1/12; B65G 1/10

(52) U.S. Cl. 414/271; 414/272

(57) ABSTRACT

Transportation devices of an aerial cableway, such as gondolas or chairs, are stored in a storage region, which includes at least one storage rail. By way of a conveyor device the transportation devices are conveyed from the endless cableway region of an aerial cableway station to the storage region and back, and by way of a device on the storage rail said transportation devices are slid along. The sliding device is a motor-driven trolley that can be moved to and fro along the storage rail. The transportation devices are conveyed to the storage rail or storage rails by way of the conveyor device, wherein the transportation devices are pushed further and further along the storage rail by the transportation devices that follow. For transporting the transportation devices back from the storage rail or storage rails, the trolley is used, which, preferably acting upon the last transportation devices stored at the end of the storage track, pushes all the transportation devices to the conveyor device.

### CROSS-REFERENCE TO RELATED APPLICATION

This application claims the priority, under 35 U.S.C. § 119, of Austrian patent application A 2011/2006, filed Dec. 4, 2006; the prior application is herewith incorporated by reference in its entirety.

### BACKGROUND OF THE INVENTION

### Field of the Invention

The invention relates to a system for storing transportation devices, such as, for example, gondolas or lift chairs, of an aerial cableway system, wherein in an endless cableway region the transportation devices can be coupled to, and decoupled from, a traction cable and/or hauling cable. There is provided a storage region for the transportation devices with at least one storage rail, and a conveyor device for conveying the transportation devices from the endless cableway region to the storage region and back. Finally, there is provided a device for sliding the transportation devices along the storage rail.

In order to protect transportation devices, such as gondolas and chairs, of an aerial cableway installation from exterior influences, such as inclement weather, during times outside operating hours, the transportation devices are kept in a protected region. The protected regions will hereinafter be referred to as the storage region, as a garage, or as a reservoir.

Such a device is known, for example, from the commonly assigned U.S. Pat. No. 4,958,574 and its counterpart European patent application EP 0 369 981 A. There, at least one storage rail that can be swiveled on a horizontal axis is used, which storage rail can be swiveled to two inclined positions. In the first inclined position of the storage rail the transportation devices conveyed from the conveyor rail can be moved by gravity along the storage rail away from the conveyor rail, while in the second inclined position of the storage rail the transportation devices that are stored on said storage rail can be moved by gravity to the conveyor rail. Such installations are, however, associated with a disadvantage in that the storage rails, due to their ability to swivel, are limited in length, and consequently a substantial number of storage rails located side by side are required, which increases technical expenditure in the storage region.

Alternative solutions are also known, in which solutions chain conveyors, roller conveyor installations or the like are used which extend along the entire length of the storage rail. However, these solutions are expensive from the point of view of construction, and are therefore expensive from the point of view of installation costs as well as service and maintenance costs.

### BRIEF SUMMARY OF THE INVENTION

It is accordingly an object of the invention to provide a cableway system with a storage region for the transportation devices which overcomes the above-mentioned disadvantages of the heretofore-known devices and methods of this general type and which satisfies the objects that, with little technical expenditure, as great a number of transportation devices as possible can be conveyed into and out of the storage region.

With the foregoing and other objects in view there is provided, in accordance with the invention, a system for storing transportation devices of an aerial cableway, wherein transportation devices of the aerial cableway are coupled to, and decoupled from, a traction cable and/or hauling cable in an endless cableway region, the system which comprises:

a storage region for the transportation devices with at least one storage rail;

a conveyor device for conveying the transportation devices from the endless cableway region to the storage region and back; and

a motor-driven trolley configured to be moved to and fro along said storage rail for sliding the transportation devices along said storage rail.

In other words, the objects of the invention are achieved by providing the device for sliding the transportation devices in the form of a motor-driven trolley that can be moved to and fro along the storage rail.

The invention takes advantage of the fact that the transportation devices are moved to the storage rail or storage rails by a conveyor device that is present anyway, by means of which conveyor device the transportation devices are conveyed from the endless cableway region of the aerial cableway station to the storage region, wherein the transportation devices are pushed further and further along the storage rail by the transportation devices that follow. For transporting the transportation devices back from the storage rail or storage rails, the technically relatively simply designed trolley is used, which, preferably acting upon the last transportation device stored at the end of the storage track, pushes all the transportation devices to the conveyor device that handles onward transport of the transportation devices to the endless cableway region of the aerial cableway station.

Although it would be possible for the trolley to drive along a dedicated rail, or some comparable device, beside the storage rail, within the context of the invention it is preferred if the vehicle travels on the storage rail. This makes it possible to drive the transportation devices without additional technical expenditure along the storage rail(s).

In the simplest embodiment the trolley is a device of simple design that travels to and fro on wheels on the storage rail or on an additional running rail that is arranged parallel beside said storage rail and if need be is affixed to said storage rail. For example a pull cable or a cable winch can be used as a drive.

However, the trolley can also be the running gear of a motor-driven vehicle that can travel along the storage rail.

Since the storage rail according to the invention can be relatively long, it is possible to store a relatively large number of transportation devices on the storage rail, which will then, however, all have to be driven by a single vehicle when they are to be pushed back to the conveyor device. In order to be able to generate adequate driving force for this, the vehicle if it is not pulled but comprises a drive of its own comprises at least one ballast body. This ballast body, of which there is at least one, ensures adequate static friction between the drive wheel or drive wheels of the trolley and the storage rail to ensure that the drive force is adequate.

Preferably, the ballast body is arranged underneath the trolley. It is further preferred if the ballast body is suspended from the trolley by way of a suspension bar. In the region below the storage rail there is sufficient space anyway because this is the region where the transportation devices have to be placed.

In the context of the invention there are several preferred embodiments as to how the trolley or the vehicle can best act upon the last transportation device stored on the storage rail so as to transmit the pushing force. One embodiment is characterized in that on the trolley of the vehicle a pushing device is arranged that can act upon the running gear of the transportation devices. As an alternative it is, however, also possible for the pushing device to be arranged on the ballast body, or for the pushing device to be arranged on the suspension bar. The first-mentioned embodiment is preferred in the case of chairs, because the chairs are arranged in a queue directly by their running gear or clamps. The two other embodiments are preferably used in the case of gondolas, which would otherwise be placed in an inclined position during transport with the vehicle according to the invention, which is not the case if the force acts upon the gondola body.

For the purpose of driving the vehicle, preferably an electric motor is arranged on the trolley. Said electric motor can be connected to a stationary current source by way of a current cable. However, if a current cable is not desirable there is also the option of supplying current to the electric motor by way of a battery or a rechargeable battery on the vehicle. The battery or the rechargeable battery automatically contributes to an increase in weight of the vehicle and can preferably be arranged in the ballast body. A current conductor rail on or along the storage rail would be an alternative power supply option.

### BRIEF DESCRIPTION OF THE SEVERAL VIEWS OF DRAWING

FIG. 1 is a top view of a terminal station of an aerial cableway system provided with a storage region;

FIG. 2 is a partial side view of the end of a storage rail with a first embodiment of a vehicle according to the invention;

FIG. 3 is a view, from the right-hand side, of the configuration of FIG. 2;

FIG. 4 is a side view of the end of a storage rail with a second embodiment of a vehicle according to the invention; and

FIG. 5 is a view, from the right-hand side, of the configuration of FIG. 4.

### DETAILED DESCRIPTION OF THE INVENTION

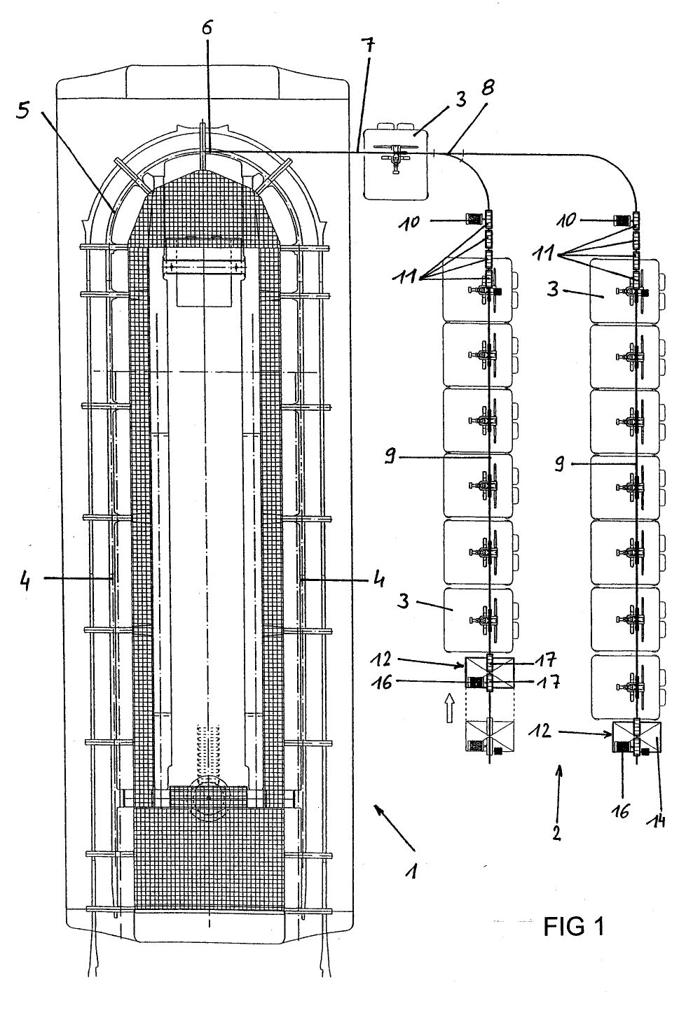

Referring now to the figures of the drawing in detail, FIG. 1 shows a station 1 of an aerial cableway installation. A storage region 2 is located beside the station 1 for storing transportation devices 3. In the exemplary embodiment, the transportation devices are gondolas. Usually this storage region 2 is an enclosed space or a hall in which the transportation devices 3 can be kept protected from the weather, and in which service/maintenance and cleaning work can also be carried out.

The station 1 of the aerial cableway can be designed in a manner that is known per se, so that in the present document only the essential components of the station 1 are described. After the transportation devices 3 have been decoupled from a traction cable and/or hauling cable that continues to move at constant speed, said transportation devices are guided along an endless cableway rail 4, where they are first decelerated to a lower speed. The transportation devices 3 are then guided, along a region 5, by 180° around a deflection wheel or pulley (not shown in detail), after which said transportation devices are again accelerated to a speed which corresponds to the speed of the traction cable and/or hauling cable, before again being coupled to the traction cable and/or hauling cable.

In the region 5 of the endless cableway rail 4 a switch point 6 is arranged, by way of which the transportation devices 3 are conveyed to the storage region 2 by means of a conveyor device 7 that comprises a conveyor rail and a drive device. The switch point 6 and the conveyor device 7 can also be designed as is known from the state of the art, e.g. from U.S. Pat. No. 4,958,574 and EP 0 369 981 A, and are therefore not described in detail.

On the conveyor device 7 a further switch point 8 is provided, at which a first storage rail 9 branches off. At the end of the conveyor device 7 the conveyor rail makes a transition to a second storage rail 9. It is understood that in the present invention only a single storage rail 9 or more than two storage rails 9 can also be provided.

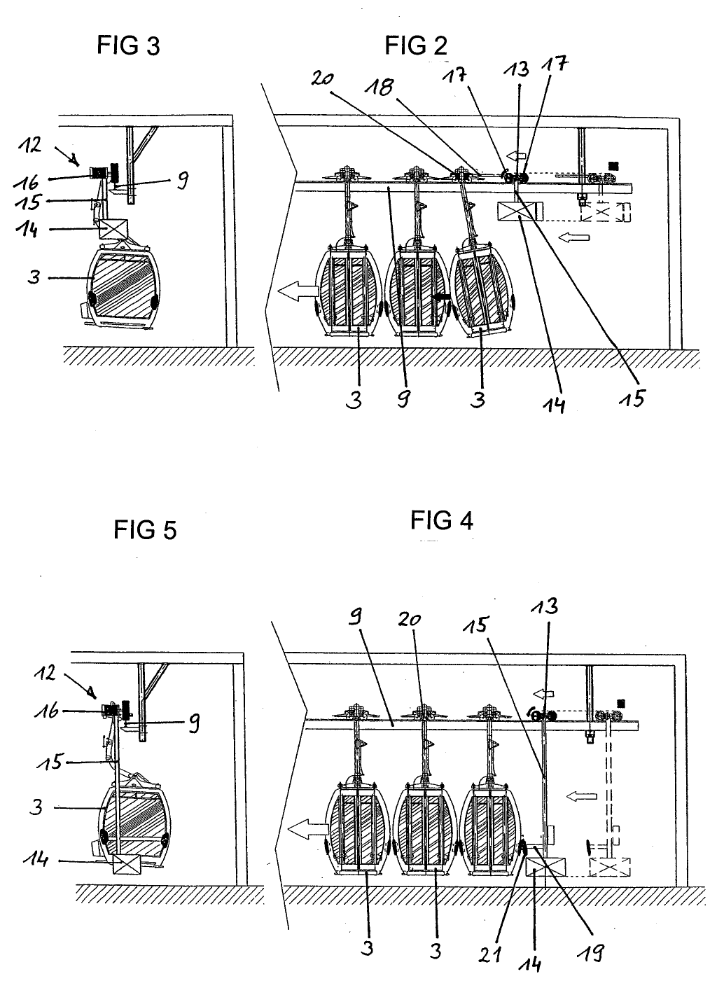

At the beginning of each storage rail 9, which beginning faces the conveyor device 7, a drive device in the form of an electric motor 10, for example comprising four drive wheels 11, is provided, by means of which the transportation devices 3 arriving from the conveyor device 7 are pushed onto the horizontally arranged storage rails 9. At the opposite end of each storage rail 9 a vehicle 12 is arranged, which in the exemplary embodiments shown in FIGS. 2 to 5 comprises a trolley 13 and a ballast body 14 which is suspended from the trolley 13 by way of a suspension bar 15. Since the trolley 13 comprises a single track, the vehicle 12 is automatically stabilized by the ballast body 14 arranged below the trolley 13. Furthermore, the ballast body 14 provides the necessary static friction between the wheels 16 of the trolley 13 and the storage rail 9.

An electric motor 17 is used to drive the vehicle 12, which electric motor 17 is arranged on the trolley 13, and drives either one wheel 17 or both wheels 17. In order to drive the electric motor 17, in a way that is known per se, a power cable that is connected in a stationary manner in the storage region 2 can be used. As an alternative it is, however, also possible for a battery or a rechargeable battery to be used to supply power to the electric motor 17 so that there is no need to provide a cable following system along the storage rail 9. At the same time the battery or rechargeable battery can be used as ballast in the ballast body 14.

In order to transfer the pushing force of the vehicle 12 to the transportation devices 3, the two pushing devices 18 and 19 shown in FIGS. 2 and 4 are provided as exemplary embodiments. In the first exemplary embodiment, shown in FIG. 2, the pushing device is a push bar that is attached to the trolley 13 and that comes to rest against the running gear 20 of the immediately adjacent gondola 3 when the gondolas 3 are to be pushed from the storage rail 9.

In the embodiment shown in FIG. 4, the pushing device 19 is a push rod that is attached to the suspension bar 15. In order to prevent the gondolas 3 from getting damaged, a buffer 21 is affixed to the end of the push bar, which end faces the adjacent gondola 3. In principle it would, of course, also be possible to attach the pushing device 19 to the ballast body 14.

With the device according to the invention, the process of storing the transportation devices 3 in the storage region 2 can be carried out such that at close of operation or during an interruption in operation, during which interruption the transportation devices 3 are to be parked in the storage region, the switch point 6 is switched over so that the transportation devices approaching the station 1 are directed to the conveyor device 7. When the switch point 8 is switched accordingly, the conveyor device 7 conveys the transportation devices 3 to the first storage rail 9. Where the storage rail 9 commences, the drive wheels 11 provide the further drive for the transportation devices 3. As soon as a transportation device 3 has moved past the drive wheels 11, it stops and is then pushed by a subsequent transportation device 3 further in the direction towards the end of the storage rail 9. This continues until the first storage rail 9 is completely full of transportation devices 3. During this time the vehicle 12 is located at the very end of the storage rail 9, as indicated in dashed lines in FIGS. 2 and 4 on the extreme right-hand side of the storage rail 9.

The switch point 8 is then switched so that the further transportation devices 3 are onward conveyed to the second storage rail 9. Filling the second storage rail 9 takes place in exactly the same manner as described in the context of the first storage rail 9.

If the transportation devices 3 are to be returned to operation, the vehicle 12 of either the first or the second storage rail 9 is put into operation and pushes the last transportation device 3 in the direction towards the beginning of the storage rail 9 until the first transportation device on this storage rail 9 enters the effective region of the drive wheels 11 that push this transportation device 3 onward to the conveyor device 7 until it is taken over by the conveyor device 7, and by way of the switch point 6 is pushed into the endless cableway region 4, 5 of the station 1. This process is carried out until all the transportation devices 3 are pushed off the storage rail 9. The vehicle 12 then returns to the waiting position at the end of the storage rail 9. During this time, the drive of the transportation devices 3 in the endless cableway region of the station 1 is in the opposite direction of normal operation so that the transportation devices 3 can gradually be coupled to the cable.

Subsequently, the switch point 8 is switched over, and the transportation devices 3 on the second storage rail 9 are returned to operation in an analogous manner. It is understood that storage and return to operation of transportation devices 3 have to be repeated a corresponding number of times in cases where more than two storage rails 9 are used.

Instead of using a vehicle 12 with a trolley 13 and a motor 16 arranged thereon, it would also be possible to use only a trolley 13 of a very simple design, which trolley is, for example, moved along by way of a pull cable or a winch. In this arrangement it would be adequate, and this also applies to the described embodiment of the vehicle 12, if the trolley 13 is pulled or driven only in the direction to the beginning of the storage rail 9 or the conveyor device 7, because the trolley 13 is anyway pushed towards the end of the storage rail 9 by the last transportation device 3 on the storage rail 9.

In principle, within the context of the invention it would also be possible for the trolley 13 or the vehicle 12 not to be arranged directly on the respective storage rail 9 and not to move directly along said storage rail 9, which in each case requires one vehicle 12 for each storage rail 9. Instead it would also be possible to use only a single vehicle 12 that can be moved, on a bridge, from one storage rail 9 to the next storage rail 9 and along this storage rail 9.

1. A system for storing transportation devices of an aerial cableway, wherein transportation devices of the aerial cableway are coupled to, and decoupled from, a traction cable and/or hauling cable in an endless cableway region, the system which comprises:
a storage region for the transportation devices with at least one storage rail;
a conveyor device for conveying the transportation devices from the endless cableway region to the storage region and back; and
a motor-driven trolley configured to be moved to and fro along said storage rail for sliding the transportation devices along said storage rail.

2. The system according to claim 1, wherein said trolley is configured to act only upon a respectively last transportation device stored on said storage track.

3. The system according to claim 1, wherein said trolley is disposed between a last transportation device stored on said storage rail and an end of said storage rail opposite said conveyor device.

4. The system according to claim 1, wherein said trolley travels on said storage rail.

5. The system according to claim 1, wherein said trolley travels on a rail affixed to said storage rail.

6. The system according to claim 1, wherein said trolley is a running gear of a motor-driven vehicle configured for movement along said storage rail.

7. The system according to claim 1, wherein said trolley comprises at least one ballast body.

8. The system according to claim 7, wherein said ballast body is disposed underneath said trolley.

9. The system according to claim 8, which comprises a suspension bar disposed to suspend said ballast body from said trolley.

10. The system according to claim 1, which comprises a pushing device disposed on said trolley and configured to act upon a running gear of a transportation device.

11. The system according to claim 7, which comprises a pushing device disposed on said ballast body for acting upon the transportation devices.

12. The system according to claim 9, which comprises a pushing device mounted to said suspension bar and disposed to act upon the transportation devices.

13. The system according to claim 1, which comprises an electric motor disposed on said trolley.

14. The system according to claim 13, wherein said electric motor is connected to a stationary current source in said storage region by way of a current cable.

15. The system according to claim 13, wherein said electric motor is energized by way of a battery or a rechargeable battery on said trolley.

16. The system according to claim 15, wherein said battery or rechargeable battery is disposed in a ballast body supported on said trolley.

17. The system according to claim 13, which comprises a current conductor rail disposed to supply current to said electric motor.

18. The system according to claim 1, which comprises a pull cable forming a drive for said trolley.

19. The system according to claim 18, wherein said pull cable comprises a closed cable loop with a drive motor.

20. The system according to claim 18, wherein said pull cable comprises a traction cable with a winch.

21. The device according to claim 1, wherein said at least one storage rail is one of a plurality of storage rails in said storage region, and wherein one trolley is associated with each said storage rail.
